(19) United States
(12) Patent Application Publication
(10) Pub. No.: US 2019/0181494 A1
(43) Pub. Date: Jun. 13, 2019

(54) NONAQUEOUS ELECTROLYTIC SOLUTION AND LITHIUM ION SECONDARY BATTERY

(71) Applicant: NEC CORPORATION, Tokyo (JP)

(72) Inventors: Katsumi MAEDA, Tokyo (JP); Qian CHENG, Tokyo (JP)

(73) Assignee: NEC CORPORATION, Tokyo (JP)

(21) Appl. No.: 16/321,891

(22) PCT Filed: Jul. 14, 2017
(86) PCT No.: PCT/JP2017/025786

§ 371 Date: Jan. 30, 2019

(30) Foreign Application Priority Data
Aug. 3, 2016 (JP) 2016-153029

(51) Int. Cl. H01M 10/0525; H01M 10/0567; H01M 10/0568; H01M 10/0569; H01M 4/525

(52) U.S. Cl. CPC H01M 10/0525; H01M 10/0567; H01M 4/525; H01M 10/0569; H01M 10/0568

(57) ABSTRACT

A nonaqueous electrolytic solution comprising a nonaqueous solvent, an electrolyte, lithium difluorophosphate, and a difluoroboron complex compound represented by general formula (1):

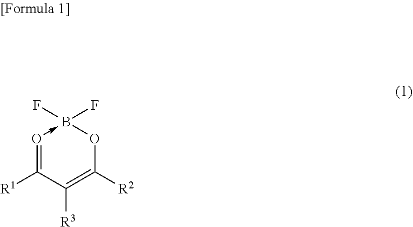

wherein R¹ and R² each independently represent a substituted or unsubstituted alkyl group having one to six carbon atoms, a substituted or unsubstituted aryl group, a substituted or unsubstituted heteroaryl group, or a substituted or unsubstituted alkoxy group, and R³ represents a hydrogen atom, a substituted or unsubstituted aryl group, or a substituted or unsubstituted heteroaryl group, wherein the content of lithium bis(fluorosulfonyl)imide as the electrolyte is 0 to 80 mol % based on the total amount of moles of the electrolyte.

### TECHNICAL FIELD

The present invention relates to a nonaqueous electrolytic solution and a lithium ion secondary battery.

### BACKGROUND ART

Lithium ion secondary batteries have been put into practical use as a battery for small electronic devices such as notebook computers and cellular phones because of their advantages such as high energy density, small self-discharge, and excellent long-term reliability. In recent years, development of lithium ion secondary batteries has progressed for batteries for electrical vehicles, batteries for household use, and batteries for power storage.

For lithium ion secondary batteries, carbon materials such as graphite are used as a negative electrode active material and solutions containing a lithium salt such as LiPF₆ as an electrolyte dissolved in a linear or cyclic carbonate solvent are used as an electrolytic solution.

Such lithium ion secondary batteries are required to have higher energy density and excellent charge rate characteristics allowing charging in short time even in using a battery with high energy density, and improvement in the charge rate characteristics has been studied. In addition, batteries which do not decrease in capacity even after repeated cycles at high charge/discharge rates (has a high capacity retention rate, i.e., excellent cycle characteristics) have been demanded.

However, in a secondary battery using such a nonaqueous electrolytic solution, for example, a solvent in the electrolytic solution undergoes reductive decomposition on the surface of a negative electrode, and the decomposition product deposits on the surface of the negative electrode to increase the resistance, or a gas generated through the decomposition of the solvent causes the battery to swell. On the surface of a positive electrode, the solvent undergoes oxidative decomposition, and the decomposition product deposits on the surface of the positive electrode to increase the resistance, or a gas generated through the decomposition of the solvent causes the battery to swell. As a result, the rate characteristics and cycle characteristics of a secondary battery are lowered, which disadvantageously causes degradation of battery characteristics.

To prevent the occurrence of such problems, a compound having a function to form a protective film is added into a nonaqueous electrolytic solution. Specifically, it is known that the compound added into an electrolytic solution is intentionally allowed to decompose on the surface of an electrode active material in initial charging so that the decomposition product forms a protective film having a protective function to prevent further decomposition of a solvent, or an SEI (Solid Electrolyte Interface). It has been reported that the protective film formed on the surface of an electrode suitably suppresses the chemical reaction or decomposition of a solvent on the surface of an electrode, and as a result exerts an effect of maintaining the battery characteristics of a secondary battery (Non Patent Literature 1).

Addition of, for example, vinylene carbonate, fluoroethylene carbonate, or maleic anhydride as an additive for formation of such a protective film to an electrolytic solution has been attempted to improve battery characteristics (Non Patent Literature 1).

Further, Patent Literature 1 describes an electrolytic solution comprising lithium difluorophosphate that can serve as an additive effective for enhancement of the performance of a nonaqueous electrolytic solution battery.

Patent Literature 2 describes use of an electrolytic solution comprising at least one of 1,3-propenesultone and lithium bis(fluorosulfonyl)imide with a specific concentration for a lithium ion battery using a specific mixed active material for the positive electrode.

Patent Literature 3 describes a nonaqueous electrolytic solution comprising a nonaqueous solvent, an electrolyte salt comprising a lithium salt, and a specific difluoroboron complex compound. The patent literature also discloses that use of the nonaqueous electrolytic solution can reduce degradation of battery characteristics under a high temperature environment.

### CITATION LIST

### Patent Literature

Patent Literature 1:

JP2008-222484A
Patent Literature 2:

JP2014-192143A
Patent Literature 3:

International Publication No. WO 2016/013364

### Non Patent Literature

Non Patent Literature 1:

Journal. Power Sources, vol. 162, p. 1379-1394 (2006)

### SUMMARY OF INVENTION

### Technical Problem

Even if an electrolytic solution comprising an additive described in Non Patent Literature 1 such as vinylene carbonate and maleic anhydride is used, however, reduction of lowering of the capacity retention rate during cycles at high charge/discharge rates is still insufficient.

An object of the present invention is to provide a nonaqueous electrolytic solution capable of reducing degradation of battery characteristics during cycles at high charge/discharge rates.

Another object of the present invention is to provide a lithium ion secondary battery which has excellent charge rate characteristics and keeps a high capacity retention rate even after cycles at high charge/discharge rates (having excellent cycle characteristics).

### Solution to Problem

A nonaqueous electrolytic solution according to one aspect of the present invention comprises a nonaqueous solvent, an electrolyte, lithium difluorophosphate, and a difluoroboron complex compound represented by the following general formula (1), wherein the content of lithium bis(fluorosulfonyl)imide as the electrolyte is 0 to 80 mol % based on the total amount of moles of the electrolyte.

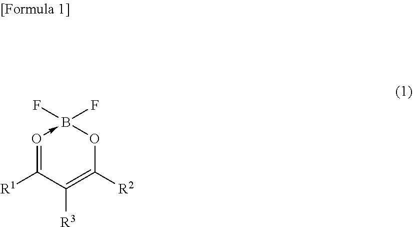

In the formula, R¹ and R² each independently represent a substituted or unsubstituted alkyl group having one to six carbon atoms, a substituted or unsubstituted aryl group, a substituted or unsubstituted heteroaryl group, or a substituted or unsubstituted alkoxy group, and R³ represents a hydrogen atom, a substituted or unsubstituted aryl group, or a substituted or unsubstituted heteroaryl group.

A lithium ion secondary battery according to an aspect of the present invention includes: a positive electrode comprising a positive electrode active material capable of occluding and releasing a lithium ion; a negative electrode comprising a negative electrode active material capable of occluding and releasing a lithium ion; and the above nonaqueous electrolytic solution.

### Advantageous Effects of Invention

Exemplary embodiments can provide a nonaqueous electrolytic solution capable of reducing degradation of battery characteristics during cycles at high charge/discharge rates. Other exemplary embodiments can provide a lithium ion secondary battery which has excellent charge rate characteristics and keeps a high capacity retention rate even after cycles at high charge/discharge rates (having excellent cycle characteristics).

### BRIEF DESCRIPTION OF DRAWING

FIG. 1 is a schematic cross-sectional view illustrating an example of the configuration of the lithium secondary battery according to the present invention.

### DESCRIPTION OF EMBODIMENTS

The present inventors found as a result of diligent study to solve the above problem that a nonaqueous electrolytic solution comprising a nonaqueous solvent, an electrolyte, lithium difluorophosphate, and a difluoroboron complex compound having a specific structure allows a lithium ion secondary battery to have excellent charge rate characteristics and keep a high capacity retention rate even during cycles at high charge/discharge rates, and thus completed the present invention.

Specifically, a nonaqueous electrolytic solution according to an exemplary embodiment comprises a nonaqueous solvent, an electrolyte, lithium difluorophosphate, and a difluoroboron complex compound represented by the above general formula (1).

The nonaqueous electrolytic solution may comprise one or two or more of the difluoroboron complex compounds. The amount of the difluoroboron complex compound to be added (content) is preferably within the range of 0.01 to 10% by mass based on the total mass of the nonaqueous electrolytic solution. The content of the lithium difluorophosphate is preferably in the range of 0.005 to 7% by mass based on the total mass of the nonaqueous electrolytic solution.

The nonaqueous electrolytic solution preferably comprises a carbonate as the nonaqueous solvent, and more preferably comprises a cyclic carbonate and a linear carbonate. The cyclic carbonate contained is preferably ethylene carbonate.

The concentration of the electrolyte in the nonaqueous electrolytic solution is preferably within the range of 0.1 to 3 mol/L, and more preferably within the range of 0.3 to 3 mol/L.

The content of lithium bis(fluorosulfonyl)imide as the electrolyte in the nonaqueous electrolytic solution is preferably 0 to 80 mol % based on the total amount of moles of the electrolyte, and it is more preferable that lithium bis(fluorosulfonyl)imide and an additional lithium salt be contained as the electrolyte. The content (the content based on the total amount of moles of the electrolyte) of lithium bis(fluorosulfonyl)imide is preferably 20 mol % or more, more preferably 30 mol % or more, and even more preferably 40 mol % or more, in terms of achievement of sufficient effect of addition (charge/discharge rate characteristics). The content of lithium bis(fluorosulfonyl)imide is preferably 80 mol % or less, more preferably 75 mol % or less, and even more preferably 70 mol % or less, in terms of achievement of sufficient effect of combined use with the additional lithium salt (e.g., corrosion-preventing effect on aluminum, etc.).

The additional lithium salt is preferably lithium hexafluorophosphate, that is, it is particularly preferable that lithium hexafluorophosphate and lithium bis(fluorosulfonyl)imide be contained as the electrolyte.

The concentration of the additional lithium salt (lithium salt other than lithium bis(fluorosulfonyl)imide) in the electrolytic solution is preferably 0.3 mol/L or more, and in the case that the additional lithium salt is lithium hexafluorophosphate, the concentration is preferably 0.3 mol/L or more.

Presumably, the difluoroboron complex compound represented by the general formula (1) undergoes chemical reaction on the surface of a negative electrode in initial charging of a battery, and the product forms a protective film having a protective function to prevent further decomposition of an electrolytic solution, or an SEI (Solid Electrolyte Interface), on the surface of an electrode. The difluoroboron complex compound represented by the general formula (1) added to a specific nonaqueous electrolytic solution comprising lithium difluorophosphate, described later, forms a protective film of high quality on the surface of an electrode to suitably suppress the chemical reaction or decomposition of an electrolytic solution on the surface of an electrode, and as a result an effect of reducing lowering of capacity even during cycles at high (fast) charge/discharge rates is provided. By virtue of this, a lithium ion secondary battery can be provided which has excellent charge/discharge rate characteristics and in addition keeps a high capacity retention rate even after cycles with high (fast) charge/discharge rates (having excellent cycle characteristics). For this reason, charging time can be shortened even in the case of high capacity, and excellent cycle characteristics are provided, and, moreover, enhanced use efficiency is achieved for a lithium ion secondary battery.

On the other hand, lithium difluorophosphate in the nonaqueous electrolytic solution can contribute primarily to enhancement of charge/discharge rate characteristics. Although details of the reason is unclear, for example, a coating film with low resistance is formed on the surface of a positive electrode in initial stages of charging, and the coating film is inferred to contribute to enhancement of charge/discharge rate characteristics.

Now, the nonaqueous electrolytic solution according to an exemplary embodiment and a lithium ion secondary battery using it will be described in detail.

### <Additive Component of Nonaqueous Electrolytic Solution>

The nonaqueous electrolytic solution according to an exemplary embodiment comprises at least one difluoroboron complex compound represented by the following general formula (1).

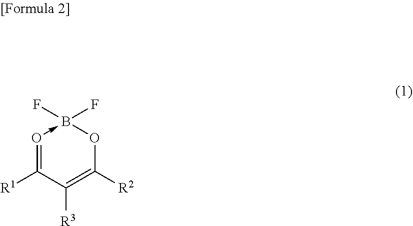

In the formula (1), R¹ and R² each independently represent a substituted or unsubstituted alkyl group having one to six carbon atoms, a substituted or unsubstituted aryl group, a substituted or unsubstituted heteroaryl group, or a substituted or unsubstituted alkoxy group, and R³ represents a hydrogen atom, a substituted or unsubstituted alkyl group having one to six carbon atoms, a substituted or unsubstituted aryl group, or a substituted or unsubstituted heteroaryl group. R³ is preferably a hydrogen atom, a substituted or unsubstituted aryl group, or a substituted or unsubstituted heteroaryl group.

In the case that R¹ and R² are different, the difluoroboron complex compound according to an exemplary embodiment is expected to have isomers represented by formula (1A) and formula (1B). In the present specification, even in the case that only the structural formula (1A) is shown as the structure of the difluoroboron complex compound, the structural formula (1B) as an isomer is also included therein unless otherwise stated. A formula (2) represents the tautomerism between the isomers represented by the formula (1A) and the formula (1B).

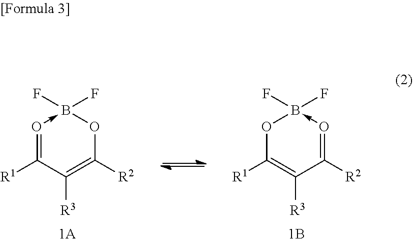

Examples of the substituted or unsubstituted alkyl group having one to six carbon atoms for R¹, R², and R³ include unsubstituted alkyl groups such as a methyl group, an ethyl group, a propyl group, an isopropyl group, a n-butyl group, an isobutyl group, a t-butyl group, a pentyl group, and a n-hexyl group, and alkyl groups with one or more hydrogen atoms of the alkyl group replaced with a substituent. Examples of the substituent include a fluorine atom, a cyano group, an ester group having two to six carbon atoms (—COOZ, where Z is an alkyl group having one to five carbon atoms), an alkoxy group having one to five carbon atoms, an aryl group, and a heteroaryl group (thienyl group, furanyl group, etc.). Two or more hydrogen atoms of the alkyl group may be each independently replaced with a different substituent. Examples of the substituted alkyl group include a trifluoromethyl group, a pentafluoroethyl group, a trifluoroethyl group, a heptafluoropropyl group, a cyanomethyl group, a benzyl group, and a 2-thienylmethyl group.

Examples of the substituted or unsubstituted aryl group for R¹, R², and R³ include unsubstituted aryl groups such as a phenyl group and a naphthyl group, and aryl groups with one or more hydrogen atoms of the aryl group replaced with a substituent. Examples of the substituent include an alkyl group having one to five carbon atoms, a fluorine atom, a cyano group, and an alkoxy group having one to five carbon atoms. Two or more hydrogen atoms of the aryl group may be each independently replaced with a different substituent. Examples of the substituted aryl group include a tolyl group, a 4-cyanophenyl group, a 2-fluorophenyl group, a 3-fluorophenyl group, a 4-fluorophenyl group, a 2,3-difluorophenyl group, a 2,4-difluorophenyl group, a 2,5-difluorophenyl group, a 2,6-difluorophenyl group, a 3,4-difluorophenyl group, a 3,5-difluorophenyl group, a 3,6-difluorophenyl group, a 2,4,6-trifluorophenyl group, a pentafluorophenyl group, and a 4-methoxyphenyl group.

Examples of the substituted or unsubstituted heteroaryl group for R¹, R², and R³ include unsubstituted heteroaryl groups such as a thienyl group (2-thienyl group, 3-thienyl group) and a furanyl group (e.g., 2-furanyl group), and heteroaryl groups with one or more hydrogen atoms of the heteroaryl group replaced with a substituent. Examples of the substituent include an alkyl group having one to five carbon atoms, a fluorine atom, a cyano group, and an alkoxy group having one to five carbon atoms. Two or more hydrogen atoms of the heteroaryl group may be each independently replaced with a different substituent. Examples of the substituted heteroaryl group include a 4-methyl-2-thienyl group and a 3-fluoro-2-thienyl group.

Examples of the substituted or unsubstituted alkoxy group for R¹ and R² include unsubstituted alkoxy groups having one to five carbon atoms such as a methoxy group, an ethoxy group, a propoxy group, a butoxy group, and a benzyloxy group, and substituted alkoxy groups such as a benzyloxy group with one or more hydrogen atoms of an alkoxy group having one to five carbon atoms replaced with a substituent. Examples of the substituent include a fluorine atom, a cyano group, an aryl group, and a heteroaryl group (thienyl group, furanyl group, etc.).

In a preferred example, R¹ and R² are each independently a group selected from the group consisting of a methyl group, a trifluoromethyl group, a pentafluoroethyl group, a phenyl group, a 2-thienyl group, a 2-furanyl group, a 2-fluorophenyl group, a pentafluorophenyl group, a 4-fluorophenyl group, a 2,4-difluorophenyl group, a 4-cyanophenyl group, an ethoxy group, and a methoxy group.

In a preferred example, R³ is an atom or a group selected from the group consisting of a hydrogen atom, a phenyl group, a 2-thienyl group, a 4-fluorophenyl group, a 2,4-difluorophenyl group, and a pentafluorophenyl group.

Specific examples of the compound represented by the above general formula (1) are shown in Table 1; however, the present invention is never limited thereto.

TABLE 1

| Compound | Structural formula |
|---|---|
| FB1 | 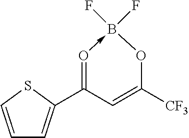 [SMILES: F[B-]1(F)OC(C(F)(F)F)=CC(c2cccs2)=[O+]1] |
| FB2 | 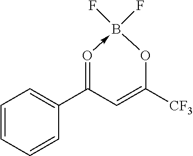 [SMILES: F[B-]1(F)OC(C(F)(F)F)=CC(c2ccccc2)=[O+]1] |
| FB3 | 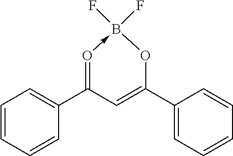 [SMILES: F[B-]1(F)OC(c2ccccc2)=CC(c2ccccc2)=[O+]1] |
| FB4 | 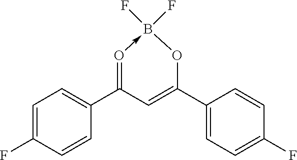 [SMILES: Fc1ccc(C2=CC(c3ccc(F)cc3)=[O+][B-](F)(F)O2)cc1] |
| FB5 | 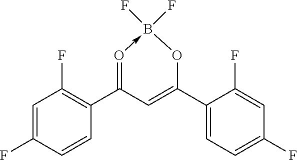 [SMILES: Fc1ccc(C2=CC(c3ccc(F)cc3F)=[O+][B-](F)(F)O2)c(F)c1] |
| FB6 | 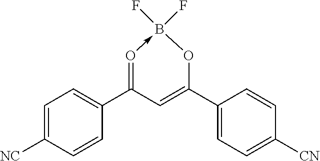 [SMILES: N#Cc1ccc(C2=CC(c3ccc(C#N)cc3)=[O+][B-](F)(F)O2)cc1] |
| FB7 | 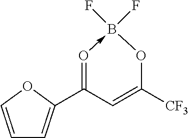 [SMILES: F[B-]1(F)OC(C(F)(F)F)=CC(c2ccco2)=[O+]1] |
| FB8 | 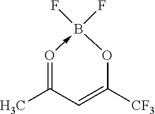 |
| FB9 | 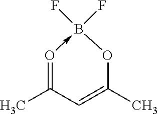 |
| FB10 | 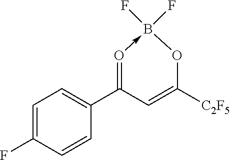 |
| FB11 | 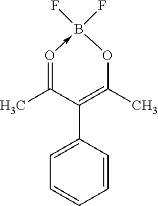 |
| FB12 | 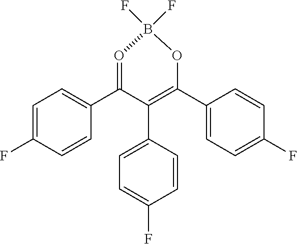 |
| FB13 | 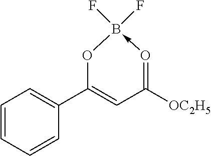 [SMILES: CCOC1=[O+][B-](F)(F)OC(c2ccccc2)=C1] |

The difluoroboron complex compound represented by the general formula (1) can be obtained, for example, by using a production method described in Tetrahedron, vol. 63, p. 9357-9358 (2007).

Examples of production methods for the difluoroboron complex compound represented by the general formula (1) include a method of reacting a diketone represented by the following formula (A-a) and boron trifluoride-diethyl ether complex with use of an appropriate solvent.

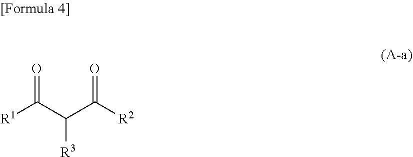

In the formula, R¹, R², and R³ are the same as R¹, R², and R³ in the general formula (1).

Examples of the solvent which can be used in the production method include: halogenated hydrocarbons such as methylene chloride, 1,2-dichloroethane, and chloroform; 1,2-dimethoxyethane; and acetonitrile. Among them, methylene chloride, 1,2-dichloroethane, and 1,2-dimethoxyethane, etc., are preferred.

A specific synthesis example is described in International Publication No. WO 2016/013364.

FB1 can be synthesized, for example, as follows.

In 50 mL of dried methylene chloride, 3 g of 4,4,4-trifluoro-1-(2-thienyl)-1,3-butanedione is dissolved, and 2.34 g of boron trifluoride-diethyl ether complex is added thereto, and the resultant is stirred at room temperature overnight. The solvent is distilled off under reduced pressure to precipitate a crystal, and hexane is added to the crystal, which is stirred for washing to afford the difluoroboron complex FB1 intended.

FB2 can be synthesized, for example, as follows.

In 40 mL of dried methylene chloride, 2 g of 4,4,4-trifluoro-1-phenyl-1,3-butanedione is dissolved, and 1.602 g of boron trifluoride-diethyl ether complex is added thereto, and the resultant is stirred at room temperature overnight. The solvent is distilled off under reduced pressure to precipitate a crystal, and hexane is added to the crystal, which is stirred for washing. Further, the crystal is dissolved in chloroform, and reprecipitated in hexane to afford the difluoroboron complex FB2 intended.

The content (amount added) of the difluoroboron complex compound represented by the above general formula (1) in the nonaqueous electrolytic solution according to an exemplary embodiment is, from the viewpoint of achieving a more sufficient effect of addition and preventing excessive addition, preferably within the range of 0.01 to 10% by mass, more preferably within the range of 0.02 to 5% by mass, and even more preferably within the range of 0.03 to 3% by mass, and, from the viewpoint of achieving a further sufficient effect of addition, preferably 0.05% by mass or more, and more preferably 0.1% by mass or more based on the total mass of the nonaqueous electrolytic solution.

The nonaqueous electrolytic solution according to an exemplary embodiment may comprise only one of the difluoroboron complex compounds represented by the above general formula (1), or two or more thereof.

In addition to the difluoroboron complex compound represented by the general formula (1), the nonaqueous electrolytic solution according to an exemplary embodiment may optionally comprise a known additive compound for nonaqueous electrolytic solutions as an additional additive component. Examples of the additional additive component include vinylene carbonate, fluoroethylene carbonate, maleic anhydride, ethylene sulfite, boronates, 1,3-propanesultone, and 1,5,2,4-dioxadithiane-2,2,4,4-tetraoxide. One of these additional additive compounds may be used singly, or two or more thereof may be used in combination.

The nonaqueous electrolytic solution according to an exemplary embodiment further comprises lithium difluorophosphate (LiPO₂F₂).

Lithium difluorophosphate contained in the nonaqueous electrolytic solution can enhance charge/discharge rate characteristics. Although details of the reason is unclear, for example, a coating film derived from lithium difluorophosphate with low resistance is formed on the surface of a positive electrode in initial stages of charging, and the coating film is inferred to enhance charge/discharge rate characteristics. The content of lithium difluorophosphate contained in the nonaqueous electrolytic solution is, from the viewpoint of achieving a more sufficient effect of addition and preventing excessive addition, preferably within the range of 0.005% by mass to 7% by mass, and more preferably within the range of 0.01% by mass to 5% by mass, and, from the viewpoint of achieving a further sufficient effect of addition, preferably 0.1% by mass or more, and more preferably 0.5% by mass or more.

### <Nonaqueous Solvent>

Examples of the nonaqueous solvent contained in the nonaqueous electrolytic solution according to an exemplary embodiment include a cyclic carbonate, a linear carbonate, a linear ester, a lactone, an ether, a sulfone, a nitrile, and a phosphate, and a cyclic carbonate and a linear carbonate are preferred.

Specific examples of the cyclic carbonate include propylene carbonate, ethylene carbonate, butylene carbonate, vinylene carbonate, and vinylethylene carbonate.

Specific examples of the linear carbonate include dimethyl carbonate, diethyl carbonate, dipropyl carbonate, dibutyl carbonate, ethyl methyl carbonate, methyl propyl carbonate, methyl isopropyl carbonate, and methyl butyl carbonate.

Specific examples of the linear ester include methyl formate, methyl acetate, methyl propionate, ethyl propionate, methyl pivalate, and ethyl pivalate.

Specific examples of the lactone include γ-butyrolactone, δ-valerolactone, and α-methyl-γ-butyrolactone.

Specific examples of the ether include tetrahydrofuran, 2-methyltetrahydrofuran, 1,3-dioxolane, 1,3-dioxane, 1,4-dioxane, 1,2-dimethoxyethane, 1,2-diethoxyethane, and 1,2-dibutoxyethane.

Specific examples of the sulfone include sulfolane, 3-methylsulfolane, and 2,4-dimethylsulfolane.

Specific examples of the nitrile include acetonitrile, propionitrile, succinonitrile, glutaronitrile, and adiponitrile.

Specific examples of the phosphate include trimethyl phosphate, triethyl phosphate, tributyl phosphate, and trioctyl phosphate.

One of the above nonaqueous solvents may be used singly, or two or more thereof may be used in combination. Examples of the combination of a plurality of nonaqueous solvents include a combination of a cyclic carbonate and a linear carbonate, and a combination of a cyclic carbonate and a linear carbonate with addition of a linear ester, a lactone, an ether, a nitrile, a sulfone, or a phosphate as a third solvent. Among them, combinations at least comprising a cyclic carbonate and a linear carbonate are preferred for achieving excellent battery characteristics.

Further, a fluorinated ether solvent, a fluorinated carbonate solvent, or a fluorinated phosphate, etc., as a third solvent, may be added to a combination of a cyclic carbonate and a linear carbonate.

Specific examples of the fluorinated ether solvent include CF₃OCH₃, CF₃OC₂H₅, F(CF₂)₂OCH₃, F(CF₂)₂OC₂H₅, F(CF₂)₃OCH₃, F(CF₂)₃OC₂H₅, F(CF₂)₄OCH₃, F(CF₂)₄OC₂H₅, F(CF₂)₅OCH₃, F(CF₂)₅OC₂H₅, F(CF₂)₈OCH₃, F(CF₂)₈OC₂H₅, F(CF₂)₉OCH₃, CF₃CH₂OCH₃, CF₃CH₂OCHF₂, CF₃CF₂CH₂OCH₃, CF₃CF₂CH₂OCHF₂, CF₃CF₂CH₂O(CF₂)₂H, CF₃CF₂CH₂O(CF₂)₂F, HCF₂CH₂OCH₃, H(CF₂)₂OCH₂CH₃, H(CF₂)₂OCH₂CF₃, H(CF₂)₂CH₂OCHF₂, H(CF₂)₂CH₂O(CF₂)₂H, H(CF₂)₂CH₂O(CF₂)₃H, H(CF₂)₃CH₂O(CF₂)₂H, H(CF₂)₄CH₂O(CF₂)₂H, (CF₃)₂CHOCH₃, (CF₃)₂CHCF₂OCH₃, CF₃CHFCF₂OCH₃, CF₃CHFCF₂OCH₂CH₃, CF₃CHFCF₂CH₂OCHF₂, CF₃CHFCF₂CH₂OCH₂CF₂CF₃, H(CF₂)₂CH₂OCF₂CHFCF₃, CHF₂CH₂OCF₂CFHCF₃, F(CF₂)₂CH₂OCF₂CFHCF₃, CF₃(CF₂)₃OCHF₂.

Examples of the fluorinated carbonate solvent include fluoroethylene carbonate, fluoromethyl methyl carbonate, 2-fluoroethyl methyl carbonate, ethyl-(2-fluoroethyl) carbonate, (2,2-difluoroethyl) ethyl carbonate, bis(2-fluoroethyl) carbonate, and ethyl-(2,2,2-trifluoroethyl) carbonate.

Examples of the fluorinated phosphate include tris(2,2,2-trifluoroethyl) phosphate, tris(trifluoromethyl) phosphate, and tris(2,2,3,3-tetrafluoropropyl) phosphate.

### <Electrolyte>

Specific examples of the electrolyte contained in the nonaqueous electrolytic solution according to an exemplary embodiment include lithium salts such as lithium hexafluorophosphate (LiPF₆), lithium bis(fluorosulfonyl)imide (LiN(SO₂F)₂), LiBF₄, LiClO₄, LiN(SO₂CF₃)₂, LiN(SO₂C₂F₅)₂, CF₃SO₃Li, C₄F₉SO₃Li, LiAsF₆, LiAlCl₄, LiSbF₆, LiPF₄(CF₃)₂, LiPF₃(C₂F₅)₃, LiPF₃(CF₃)₃, (CF₂)₂(SO₂)₂NLi, (CF₂)₃(SO₂)₂Li, lithium bis(oxalate)borate, and lithium difluoro(oxalato)borate. One of these lithium salts may be used singly, or two or more thereof may be used in combination.

Among these electrolytes, it is particularly preferable that LiPF₆ (lithium hexafluorophosphate) and LiN(SO₂F)₂ (lithium bis(fluorosulfonyl)imide) be contained. Use of an electrolytic solution containing LiN(SO₂F)₂ can enhance charge rate characteristics. On the other hand, use of an electrolytic solution containing LiN(SO₂F)₂ singly disadvantageously causes the corrosion of aluminum in a current collector of a positive electrode. Therefore, use of both LiPF₆ and LiN(SO₂F)₂ as the electrolyte is preferred, and the concentration of LiPF₆ in the electrolytic solution in this case is more preferably 0.3 mol/L (M) or more. By virtue of this, the corrosion of aluminum can be prevented while high charge rate characteristics are maintained. In using LiN(SO₂F)₂, the concentration of LiN(SO₂F)₂ in the electrolytic solution is, from the viewpoint of achieving a sufficient effect of addition, preferably 0.1 mol/L or more, and more preferably 0.2 mol/L or more, and, from the viewpoint of preventing the corrosion of aluminum, preferably 1.7 mol/L or less, more preferably 1.5 mol/L or less, and even more preferably 1.0 mol/L or less.

The concentration of the electrolyte dissolving in the nonaqueous solvent in the nonaqueous electrolytic solution is preferably within the range of 0.3 to 3 mol/L, and more preferably within the range of 0.5 to 2 mol/L. If the concentration of the electrolyte is 0.3 mol/L or more, a more sufficient ion conductivity can be achieved; and if the concentration of the electrolyte is 3 mol/L or less, increase in the viscosity of the electrolytic solution can be reduced, and a more sufficient ion mobility and impregnating ability can be achieved.

### <Lithium Ion Secondary Battery>

A lithium ion secondary battery according to an exemplary embodiment primarily includes a positive electrode, a negative electrode, a nonaqueous electrolytic solution (a nonaqueous electrolytic solution with the difluoroboron complex compound represented by the general formula (1), an electrolyte, and lithium difluorophosphate dissolved in a nonaqueous solvent), and a separator disposed between the positive electrode and the negative electrode. For the nonaqueous electrolytic solution, the above-described nonaqueous electrolytic solution can be suitably used. Constitutional members other than the nonaqueous electrolytic solution such as the positive electrode, the negative electrode, and the separator are not limited, and common constitutional members for a typical lithium ion secondary battery can be applied. Constitutional members other than the nonaqueous electrolytic solution suitable for the lithium ion secondary battery according to an exemplary embodiment will be described below.

### <Positive Electrode>

For the positive electrode in the lithium ion secondary battery according to an exemplary embodiment, for example, a positive electrode in which a positive electrode active material layer comprising a positive electrode active material and a binder for positive electrodes is formed to cover a positive electrode current collector can be used.

For the positive electrode active material, a lithium composite metal oxide comprising a transition metal such as cobalt, manganese, and nickel, and lithium can be used.

Specific examples of the lithium composite metal oxide include LiCoO₂, LiMnO₂, LiMn₂O₄, LiNiO₂, LiCol₁₋ₓNiₓO₂(0.01<x<1), LiNi_{1/2}Mn_{3/2}O₄, LiNiₓCo_{y}Mn_{z}O₂(x+y+z=1), and LiNi_{0.5}Mn_{1.5}O₄. For the positive electrode active material, a lithium-containing olivine-type phosphate such as LiFePO₄ can be used.

In addition, lithium composite metal oxides in which Li is present more than the stoichiometric composition of the above lithium composite metal oxides are included. Examples of the lithium composite metal oxide with excessive Li include Li₁₊ₐNiₓMn_{y}O₂(0<a≤0.5, 0<x<1, 0<y<1), Li₁₊ₐNiₓMn_{y}M_{z}O₂ (0<a≤0.5, 0<x<1, 0<y<1, 0<z<1, M is Co or Fe), and Li_{α}Ni_{β}Co_{γ}Al_{δ}O₂ (1≤α≤1.2, β+γ+δ=1, β≥0.7, γ≤0.2).

To enhance cycle characteristics and safety or to enable use at a high charging potential, a part of a lithium composite metal oxide may be replaced with another element. For example, a part of cobalt, manganese, or nickel may be replaced with at least one or more elements such as Sn, Mg, Fe, Ti, Al, Zr, Cr, V, Ga, Zn, Cu, Bi, Mo, and La, or a part of oxygen may be replaced with S or F, or the surface of the positive electrode may be coated with a compound containing these elements.

Specific examples of the composition of the lithium composite metal oxide according to an exemplary embodiment include LiMnO₂, LiCoO₂, LiNiO₂, LiMn₂O₄, LiCo_{0.8}Ni_{0.2}O₂, LiNi_{1/2}Mn_{3/2}O₄, LiNi_{1/3}Co_{1/3}Mn_{1/3}O₂ (abbreviated as NCM111), LiNi_{0.4}Co_{0.3}Mn_{0.3}O₂ (abbreviated as NCM433), LiNi_{0.5}Co_{0.2}Mn_{0.3}O₂(abbreviated as NCM523), LiNi_{0.5}Co_{0.3}Mn_{0.2}O₂(abbreviated as NCM532), LiFePO₄, LiNi_{0.5}Co_{0.15}Al_{0.05}O₂, LiNi_{0.8}Co_{0.1}Mn_{0.1}O₂, Li_{1.2}Mn_{0.4}Ni_{0.4}O₂, Li_{1.2}Mn_{0.6}Ni_{0.2}O₂, Li_{1.19}Mn_{0.52}Fe_{0.22}O_{1.98}, Li_{1.21}Mn_{0.46}Fe_{0.15}Ni_{0.15}O₂, LiMn_{1.5}Ni_{0.5}O₄, Li_{1.2}Mn_{0.4}Fe_{0.4}O₂, Li_{1.21}Mn_{0.4}Fe_{0.2}Ni_{0.2}O₂, Li_{1.26}Mn_{0.37}Ni_{0.22}Ti_{0.15}O₂, LiMn_{1.37}Ni_{0.5}Ti_{0.13}O_{40.0}, Li_{1.2}Mn_{0.56}Ni_{0.17}Co_{0.07}O₂, Li_{1.2}Mn_{0.54}Ni_{0.13}Co_{0.13}O₂, Li_{1.2}Mn_{0.56}Ni_{0.17}Co_{0.72}, Li_{1.2}Mn_{0.54}Ni_{0.13}Co_{0.13}O₂, LiNi_{0.8}Co_{0.15}Al_{0.05}O₂, LiNi_{0.5}Mn_{1.48}Al_{0.02}O₄, LiNi_{0.5}Mn_{1.45}Al_{0.05}O_{3.9}F_{0.05}, LiNi_{0.4}Co_{0.2}Mn_{1.25}Ti_{0.15}O₄, Li_{1.23}Fe_{0.15}Ni_{0.15}Mn_{0.46}O₂, Li_{1.26}Fe_{0.11}Ni_{0.11}Mn_{0.52}O₂, Li_{1.2}Fe_{0.20}Ni_{0.20}Mn_{0.40}O₂, Li_{1.29}Fe_{0.07}Ni_{0.14}Mn_{0.57}O₂, Li_{1.26}Fe_{0.22}Mn_{0.37}Ti_{0.15}O₂, Li_{1.29}Fe_{0.07}Ni_{0.07}Mn_{0.57}O_{2.8}, Li_{10.30}Fe_{0.04}Ni_{0.07}Mn_{0.61}O₂, Li_{1.2}Ni_{0.18}Mn_{0.54}Co_{0.08}O₂, Li_{1.23}Fe_{0.03}Ni_{0.03}Mn_{0.58}O₂.

Two or more of the lithium composite metal oxides as described above may be used in a mixture, and, for example, NCM532 or NCM523, and NCM433 can be used in a mixture in the range of 9:1 to 1:9 (in a typical example, 2:1), or NCM532 or NCM523, and LiMnO₂, LiCoO₂, or LiMn₂O₄ can be used in a mixture in the range of 9:1 to 1:9.

The synthesis method for the lithium composite metal oxides represented by the above formulas is not limited, and known synthesis methods for oxides can be applied.

One of the positive electrode active materials may be used singly, or two or more thereof may be used in combination.

For the purpose of lowering the impedance, a conductive aid may be added to the positive electrode active material layer comprising the positive electrode active material. Examples of the conductive aid include graphites such as natural graphite and artificial graphite, and carbon blacks such as acetylene black, Ketjen black, furnace black, channel black, and thermal black. More than one of the conductive aids may be appropriately used in a mixture. The amount of the conductive aid is preferably 1 to 10% by mass based on 100% by mass of the positive electrode active material.

The binder for positive electrodes is not limited, and examples thereof include polyvinylidene fluorides, vinylidene fluoride-hexafluoropropylene copolymers, and vinylidene fluoride-tetrafluoroethylene copolymers. Alternatively, styrene-butadiene copolymer rubber, polytetrafluoroethylene, polypropylene, polyethylene, polyimide, or polyamideimide, etc., may be used for the binder for positive electrodes. In particular, polyvinylidene fluoride is preferably used for the binder for positive electrodes, from the viewpoint of versatility and low cost. The amount of the binder for positive electrodes to be used is, from the viewpoint of “sufficient binding strength” and “higher energy”, which are in trade-off relation to the amount of the binder, preferably 2 to 10 parts by mass based on 100 parts by mass of the positive electrode active material.

Any common positive electrode current collector can be used, and, for example, an aluminum foil, a lath sheet of a stainless steel, or the like can be used.

To produce the positive electrode, for example, the positive electrode active material, the binder, and, as necessary, an aid such as the conductive aid are mixed together and a solvent such as N-methylpyrrolidone is added thereto and the resultant is kneaded to prepare a slurry, and the slurry is applied onto a current collector by using a doctor blade method, a die coater method, or the like, and then dried and pressurized as necessary.

### <Negative Electrode>

For the negative electrode in the lithium ion secondary battery according to an exemplary embodiment, for example, a negative electrode in which a negative electrode active material layer comprising a negative electrode active material and a binder is formed to cover a negative electrode current collector can be used. The binder binds the negative electrode active material and the current collector, and binds the negative electrode active material itself.

Examples of the negative electrode active material include lithium metal, metals or alloys capable of alloying with lithium, oxides capable of intercalating and deintercalating a lithium ion, and carbonaceous materials capable of intercalating and deintercalating a lithium ion.

Examples of the metal or alloy capable of alloying with lithium include elementary silicon, lithium-silicon alloys, and lithium-tin alloys.

Examples of the oxide capable of intercalating and deintercalating a lithium ion include silicon oxides, niobium pentoxide (Nb₂O₅), a lithium-titanium composite oxide (Li_{4/3}Ti_{5/3}O₄), and titanium dioxide (TiO₂).

Examples of the carbonaceous material capable of intercalating and deintercalating a lithium ion include carbonaceous materials such as graphite materials (artificial graphite, natural graphite), carbon blacks (acetylene black, furnace black), coke, mesocarbon microbeads, hard carbon, and graphite.

One of the negative electrode active materials may be used singly, or two or more thereof may be used in any combination at any ratio.

Among them, carbonaceous materials are preferred in terms of satisfactory cycle characteristics and stability and excellent continuous charging characteristics.

For the carbonaceous material, graphite, amorphous carbon, diamond-like carbon, carbon nanotube, or a composite material thereof can be suitably used. Graphite, which has high crystallinity, has high conductivity, and is excellent in adhesion to a current collector containing metal such as copper and voltage flatness. On the other hand, amorphous carbon, which has low crystallinity, undergoes relatively small volume expansion, and thus has a high effect of reducing the volume expansion of a whole negative electrode and is less likely to be deteriorated due to unevenness such as grain boundaries and defects. The content of the carbonaceous material in the negative electrode active material is preferably 2% by mass or more and 50% by mass or less, and more preferably 2% by mass or more and 30% by mass or less.

More preferably, a heat-treated graphite material described in Japanese Patent Application No. 2014-063287 is used for the carbonaceous material. In this case, natural graphite or artificial graphite can be used for the raw material of the graphite material. A common product of artificial graphite obtained by graphitizing coke or the like can be used. Alternatively, a product of artificial graphite obtained by graphitizing mesophase spherules called mesocarbon microbeads (MCMB) may be used. In addition, a product of artificial graphite heat-treated in a temperature range of 2000 to 3200° C. can be used. Particles of any of these raw material graphites can be used from the viewpoint of packing efficiency, mixability, formability, etc. Examples of the shape of such particles include a sphere, an ellipsoid, and a scale (flake). Common spheroidization may be performed. The graphite material as a raw material is subjected to first heat treatment in an oxidative atmosphere, and then subjected to second heat treatment in an inert gas atmosphere at a temperature higher than that for the first heat treatment step to afford a heat-treated graphite material.

The temperature for the first heat treatment for the graphite material in an oxidative atmosphere can be selected typically from the temperature range of 400 to 900° C. under normal pressure. The duration of the heat treatment is in the range of about 30 minutes to 10 hours. Examples of the oxidative atmosphere include oxygen, carbon dioxide, and air. The oxygen concentration and pressure can be appropriately adjusted.

The first heat treatment is followed by the second heat treatment in an inert gas atmosphere. The second heat treatment is performed at a temperature higher than that for the first heat treatment, and the temperature can be selected typically from the temperature range of 800° C. to 1400° C. under normal pressure. The duration of the heat treatment is in the range of about 1 hour to 10 hours. Examples of the inert gas atmosphere include a noble gas atmosphere such as Ar and a nitrogen gas atmosphere. After the second heat treatment, cleaning can be performed through water washing followed by drying.

The first and second heat treatment steps can be performed sequentially in one heating furnace. In this case, an oxidative atmosphere for the first heat treatment step is replaced with an inert gas and heating is then performed to a temperature for the second heat treatment. Alternatively, the first and second heat treatment steps can be performed separately in two, sequentially disposed heating furnaces. Moreover, a certain interval of time without affecting the surface condition of channels formed may be set between the first heat treatment step and the second heat treatment step, and an additional step such as water washing and drying may be included therebetween.

The average particle diameter of the graphite material as a raw material is preferably 1 m or larger, more preferably 2 μm or larger, and even more preferably 5 μm or larger from the viewpoint of suppression of side reaction during charging/discharging and reduction of lowering of charge/discharge efficiency, and preferably 40 μm or smaller, more preferably 35 μm or smaller, and even more preferably 30 μm or smaller from the viewpoint of input/output characteristics and electrode production (e.g., smoothness of the surface of an electrode). Here, an average particle diameter refers to a particle diameter at 50% of a cumulative value (median diameter: D50) in a particle size distribution (volume basis) in a laser diffraction/scattering method.

In terms of capacity, negative electrode active materials comprising silicon are preferred. Examples of the negative electrode active material comprising silicon include silicon and silicon compounds. Examples of the silicon include elementary silicon. Examples of the silicon compound include silicon oxides, silicates, and compounds of a transition metal and silicon such as nickel silicide and cobalt silicide.

Silicon compounds have a function to reduce the swelling and shrinking of a negative electrode active material itself due to repeated charging/discharging, and silicon compounds are more preferred from the viewpoint of charge/discharge cycle characteristics. In addition, some silicon compounds have a function to ensure the conduction among silicons. From such a viewpoint, silicon oxides are preferred for the silicon compound.

The silicon oxide is not limited, and for example, a silicon oxide represented by SiOₓ (0<x≤2) can be used. The silicon oxide may comprise Li, and a silicon oxide, for example, represented by SiLi_{y}O_{z} (y>0, 2>z>0) can be used as a silicon oxide comprising Li. The silicon oxide may comprise a trace amount of metal element or non-metal element. The silicon oxide can contain, for example, one or two or more elements selected from nitrogen, boron, and sulfur, for example, at a content of 0.1 to 5% by mass. A trace amount of metal element or non-metal element contained can enhance the conductivity of the silicon oxide. The silicon oxide may be crystalline or amorphous.

For the negative electrode active material, a negative electrode active material comprising silicon (preferably, silicon or a silicon oxide) and a carbonaceous material capable of intercalating and deintercalating a lithium ion can be used. A carbonaceous material can be contained in a negative electrode active material comprising silicon (preferably, silicon or a silicon oxide) in a composite state. As is the case with silicon oxides, carbonaceous materials have a function to reduce the swelling and shrinking of a negative electrode active material itself due to repeated charging/discharging and ensure the conduction among silicons, being a negative electrode active material. Thus, coexistence of a negative electrode active material comprising silicon (preferably, silicon or a silicon oxide) and a carbonaceous material provides more satisfactory cycle characteristics.

Examples of methods for producing a negative electrode active material containing silicon and a silicon compound include the following method. In the case that a silicon oxide is used for the silicon compound, exemplary methods include a method in which elementary silicon and a silicon oxide are mixed together and calcined at a high temperature under reduced pressure. In the case that a compound of a transition metal and silicon is used for the silicon compound, exemplary methods include a method in which elementary silicon and a transition metal are mixed together and melt, and a method in which the surface of elementary silicon is coated with a transition metal by using vapor deposition or the like.

The above-described production methods can be further combined with formation of a composite with carbon. Examples of such methods include a method in which a calcined mixture of elementary silicon and a silicon compound is introduced into an organic compound gas atmosphere at a high temperature under an oxygen-free atmosphere, and the organic compound is carbonized to form a coating layer containing carbon, and a method in which a calcined mixture of elementary silicon and a silicon compound is mixed with a precursor resin for carbon at a high temperature under an oxygen-free atmosphere, and the precursor resin is carbonized to form a coating layer containing carbon. In this way, a coating layer containing carbon can be formed on a core containing elementary silicon and a silicon compound (e.g., a silicon oxide). As a result, volume expansion due to charging/discharging can be suppressed, and a further improvement effect on cycle characteristics can be achieved.

In the case that a negative electrode active material comprising silicon is used for the negative electrode active material, a composite comprising silicon, a silicon oxide and a carbonaceous material (hereinafter, also referred to as Si/SiO/C composite) is preferred. Further, the silicon oxide preferably has a totally or partially amorphous structure. Silicon oxides having an amorphous structure can suppress the volume expansion of carbonaceous materials and silicon, which are the other negative electrode active materials. Although the mechanism is not clear, the amorphous structure of a silicon oxide presumably has some effects on film formation in the interface between a carbonaceous material and an electrolytic solution. In addition, the amorphous structure is believed to have relatively few factors due to unevenness such as grain boundaries and defects. X-ray diffraction measurement (common XRD measurement) can confirm that a silicon oxide has a totally or partially amorphous structure. Specifically, in the case that a silicon oxide does not have an amorphous structure, peaks specific to the silicon oxide are observed; and in the case that a silicon oxide has a totally or partially amorphous structure, peaks specific to the silicon oxide are observed as a broad.

Preferably, silicon is totally or partially dispersed in the silicon oxide in the Si/SiO/C composite. At least a part of silicon dispersed in the silicon oxide can further suppress the volume expansion of a whole negative electrode, and in addition can suppress the decomposition of an electrolytic solution. Observation with transmission electron microscopy (common TEM observation) and measurement with energy dispersive X-ray spectroscopy (common EDX measurement) in combination can confirm that silicon is totally or partially dispersed in a silicon oxide. Specifically, observation of the cross-section of a sample and measurement of oxygen concentration of a part corresponding to silicon dispersed in a silicon oxide can confirm that the part is not an oxide.

In the Si/SiO/C composite, for example, the silicon oxide has a totally or partially amorphous structure, and silicon is totally or partially dispersed in the silicon oxide. Such an Si/SiO/C composite can be produced by using a method as disclosed in JP2004-47404A, for example. Specifically, the Si/SiO/C composite can be obtained, for example, through CVD treatment of a silicon oxide under an atmosphere comprising an organic gas such as methane gas. The Si/SiO/C composite obtained by using such a method has a form in which the surface of a particle containing a silicon oxide comprising silicon is coated with carbon. In addition, the silicon is present as nanoclusters in the silicon oxide.

In the Si/SiO/C composite, the fraction of the silicon, the silicon oxide, and the carbonaceous material is not limited. The fraction of the silicon is preferably 5% by mass or more and 90% by mass or less, and more preferably 20% by mass or more and 50% by mass or less based on the Si/SiO/C composite. The fraction of the silicon oxide is preferably 5% by mass or more and 90% by mass or less, and more preferably 40% by mass or more and 70% by mass or less based on the Si/SiO/C composite. The fraction of the carbonaceous material is preferably 2% by mass or more and 50% by mass or less, and more preferably 2% by mass or more and 30% by mass or less based on the Si/SiO/C composite.

The Si/SiO/C composite may be a mixture of elementary silicon, a silicon oxide, and a carbonaceous material, and can be also produced by mixing elementary silicon, a silicon oxide, and a carbonaceous material via mechanical milling. For example, the Si/SiO/C composite can be obtained by mixing elementary silicon, a silicon oxide, and a carbonaceous material each of which is particulate. For example, the average particle diameter of elementary silicon can be configured to be smaller than the average particle diameter of the carbonaceous material and the average particle diameter of the silicon oxide. In this configuration, elementary silicon, which undergoes large volume change due to charging/discharging, has a relatively small particle diameter, and the carbonaceous material and silicon oxide, which undergo small volume change, have a relatively large particle diameter, and thus formation of a dendrite or a fine powder can be effectively prevented. In addition, a particle of a large particle diameter and a particle of a small particle diameter alternately intercalate and deintercalate a lithium ion during charging/discharging, which can prevent the generation of a residual stress and residual strain. The average particle diameter of elementary silicon can be, for example, 20 μm or smaller, and is preferably 15 μm or smaller. The average particle diameter of the silicon oxide is preferably ½ or less of the average particle diameter of the carbonaceous material. The average particle diameter of elementary silicon is preferably ½ or less of the average particle diameter of the silicon oxide. It is more preferable that the average particle diameter of the silicon oxide be ½ or less of the average particle diameter of the carbonaceous material and the average particle diameter of elementary silicon be ½ or less of the average particle diameter of the silicon oxide. If the average particle diameters are controlled within the range, an effect of reducing volume expansion can be more effectively achieved, and a secondary battery excellent in balance among energy density, cycle lifetime, and efficiency can be obtained. More specifically, it is preferable that the average particle diameter of the silicon oxide be ½ or less of the average particle diameter of graphite and the average particle diameter of elementary silicon be ½ or less of the average particle diameter of the silicon oxide. Even more specifically, the average particle diameter of elementary silicon can be, for example, 20 m or smaller, and is preferably 15 m or smaller.

The negative electrode active material layer preferably comprises the above negative electrode active material capable of intercalating and deintercalating a lithium ion as a main component, and specifically, the content of the negative electrode active material is preferably 55% by mass or more, and more preferably 65% by mass or more based on the total of the negative electrode active material layer comprising the negative electrode active material and the binder for negative electrodes, and various aids, as necessary.

The binder for negative electrodes is not limited, and examples thereof which can be used include polyvinylidene fluorides, vinylidene fluoride-hexafluoropropylene copolymers, vinylidene fluoride-tetrafluoroethylene copolymers, styrene-butadiene copolymer rubbers (SBR), polytetrafluoroethylenes, polypropylenes, polyethylenes, polyimides, and polyamideimides. Among them, polyimides, polyamideimides, SBRs, polyacrylic acids (including lithium salts, sodium salts, and potassium salts neutralized with an alkali), and carboxymethyl cellulose (including lithium salts, sodium salts, and potassium salts neutralized with an alkali) are preferred because of their high binding properties. The amount of the binder for negative electrodes to be used is, from the viewpoint of binding strength and energy density, which are in trade-off relation to the amount of the binder, preferably 5 to 25 parts by mass based on 100 parts by mass of the negative electrode active material.

The negative electrode current collector is not limited, and any common negative electrode current collector for a typical lithium ion secondary battery can be used. For a material of the negative electrode current collector, for example, a metal material such as copper, nickel, and SUS can be used. Among them, copper is particularly preferred for ease of processing and cost. It is preferable that the negative electrode current collector have been roughened in advance. Examples of the shape of the negative electrode current collector include a foil, a sheet, and a mesh. In addition, a current collector with holes such as an expanded metal and a punched metal can be used.

In a method for producing the negative electrode, for example, a mixture of the above-described negative electrode active material and binder, various aids, as necessary, and a solvent is kneaded to prepare a slurry, and the slurry is applied onto a current collector, and then dried and pressurized as necessary to produce the negative electrode, in the same manner as the above-described production method for the positive electrode.

### <Separator>

The separator is not limited, and a monolayer or multilayer porous film containing a resin material such as a polyolefin including polypropylenes and polyethylenes or a nonwoven fabric can be used. In addition, a film in which a resin layer of a polyolefin or the like is coated with a different type of a material or the different type of a material is laminated on the resin layer can be used. Examples of such films include a film in which a polyolefin base material is coated with a fluorine compound or an inorganic fine particle, and a film in which a polyolefin base material and an aramid layer are laminated.

The thickness of the separator is preferably 5 to 50 μm, and more preferably 10 to 40 m in terms of the energy density and mechanical strength of a battery.

### <Structure of Lithium Ion Secondary Battery>

The form of the lithium ion secondary battery is not limited, and examples thereof include a coin battery, a button battery, a cylindrical battery, a rectangular battery, and a laminate battery.

For example, a laminate battery can be produced as follows: a positive electrode, a separator, and a negative electrode are laminated alternately to form a laminate; a metal terminal called tab is connected to each electrode; the resultant is contained in a container composed of a laminate film, as an outer package; and an electrolytic solution is injected thereinto and the container is sealed.

For the laminate film, any laminate film which is stable in an electrolytic solution and has sufficient water vapor barrier properties can be appropriately selected. For such a laminate film, for example, a laminate film including a polyolefin (e.g., a polypropylene, a polyethylene) coated with an inorganic material such as aluminum, silica, and alumina can be used. In particular, an aluminum laminate film including a polyolefin coated with aluminum is preferred from the viewpoint of suppression of volume expansion.

Representative examples of layer configurations for the laminate film include a configuration in which a metal thin film layer and a heat-sealable resin layer are laminated. Other examples of layer configurations for the laminate film include a configuration in which a resin film (protective layer) containing a polyester such as a polyethylene terephthalate or a polyamide such as a nylon is further laminated on the surface of a metal thin film layer in the side opposite to a heat-sealable resin layer. In the case that a container including a laminate film containing a laminate including a positive electrode and a negative electrode is sealed, a container is formed so that the heat-sealable resin layers of the laminate film face each other to allow the heat-sealable resin layers to fuse at a portion for sealing. For the metal thin film layer of the laminate film, for example, a foil of Al, Ti, a Ti alloy, Fe, a stainless steel, a Mg alloy, or the like with a thickness of 10 to 100 μm is used. The resin used for the heat-sealable resin layer is not limited and may be any resin capable of being heat-sealed, and examples thereof include: polypropylenes, polyethylenes, and acid-modified products of them; polyphenylene sulfides; polyesters such as polyethylene terephthalates; polyamides; and ionomer resins in which an ethylene-vinyl acetate copolymer, an ethylene-methacrylic acid copolymer, or an ethylene-acrylic acid copolymer are intermolecularly linked with a metal ion. The thickness of the heat-sealable resin layer is preferably 10 to 200 μm, and more preferably 30 to 100 μm.

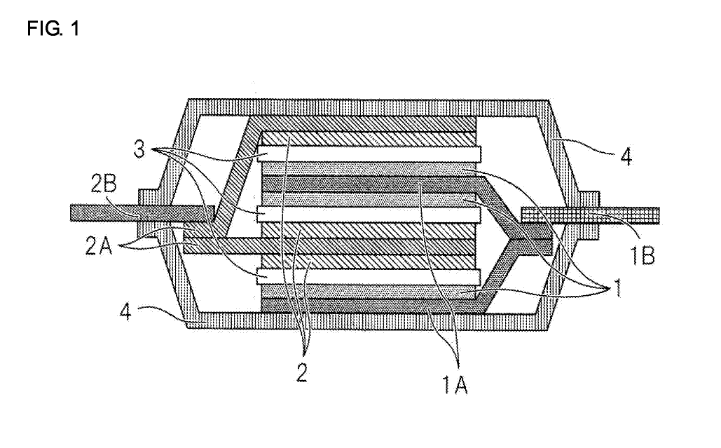

FIG. 1 illustrates one example of the structure of the lithium ion secondary battery according to an exemplary embodiment.

Positive electrode active material layers 1 comprising a positive electrode active material are formed on positive electrode current collectors 1A to constitute positive electrodes. For the positive electrodes are used a single-sided electrode in which a positive electrode active material layer 1 is formed on the surface in one side of a positive electrode current collector 1A, and a double-sided electrode in which a positive electrode active material layer 1 is formed on the surface in each side of a positive electrode current collector 1A.

Negative electrode active material layers 2 comprising a negative electrode active material are formed on negative electrode current collectors 2A to constitute negative electrodes. For the negative electrodes are used a single-sided electrode in which a negative electrode active material layer 2 is formed on the surface in one side of a negative electrode current collector 2A, and a double-sided electrode in which a negative electrode active material layer 2 is formed on the surface in each side of a negative electrode current collector 2A.

These positive electrodes and negative electrodes are disposed opposite to each other via separators 3, as illustrated in FIG. 1, and laminated. The two positive electrode current collectors 1A connect to each other in one end side, and to the connection a positive electrode tab 1B is connected. The two negative electrode current collectors 2A connect to each other in another end side, and to the connection a negative electrode tab 2B is connected. The laminate including the positive electrodes and the negative electrodes (power generation element) is contained in an outer package 4, and impregnated with an electrolytic solution. The positive electrode tab 1B and the negative electrode tab 2B protrude out of the outer package 4. The outer package 4 is formed in such a way that two rectangle laminate sheets as the outer package 4 are stacked so as to wrap the power generation element and the four edge portions are fused for sealing.

### EXAMPLE

Hereinafter, the present invention will be described in more detail with reference to Synthesis Examples and Examples, but the present invention is never limited to these examples.

### (Production Example of Positive Electrode)

LiCo_{1/3}Ni_{1/3}Mn_{1/3}O₂ as a positive electrode active material, carbon black as a conductive aid, and polyvinylidene fluoride (PVDF) as a binder for positive electrodes were weighed at a mass ratio of 94:3:3, and they were mixed with N-methylpyrrolidone to prepare a positive electrode slurry. The positive electrode slurry was applied onto one surface of a positive electrode current collector 1A including an aluminum foil with a thickness of 20 μm, and the resultant was dried and further pressed to form a positive electrode active material layer 1. In the same manner, the positive electrode active material layer 1 was formed on another surface of the positive electrode current collector 1A, and thus a double-sided electrode with a positive electrode active material layer formed on each side of a positive electrode current collector was obtained.

### (Production Example of Graphite Negative Electrode)

A graphite powder (94 parts by mass) as a negative electrode active material and PVDF (6 parts by mass) were mixed together, and N-methylpyrrolidone was added thereto to prepare a slurry. The slurry was applied onto one surface of a negative electrode current collector 2A including a copper foil (thickness: 10 μm), and the resultant was dried to form a negative electrode active material layer 2, and thus a single-sided negative electrode with a negative electrode active material layer formed on one surface of a negative electrode current collector was obtained. In the same manner, the negative electrode active material layer 2 was formed in each side of the negative electrode current collector 2A, and thus a double-sided electrode with a negative electrode active material layer formed on each side of a negative electrode current collector was obtained.

### (Production Example of Heat-Treated Graphite Negative Electrode)

A natural graphite powder (spherical graphite) with an average particle diameter of 20 m and a specific surface area of 5 m²/g was subjected to a first heat treatment step in air at 480° C. for 1 hour, and sequentially subjected to a second heat treatment step in a nitrogen atmosphere at 1000° C. for 4 hours to afford a negative electrode carbon material. Subsequently, the negative electrode material obtained (94 parts by mass) and polyvinylidene fluoride (PVDF) (6 parts by mass) were mixed together, and N-methylpyrrolidone was added thereto to prepare a slurry. The slurry was applied onto one surface of a negative electrode current collector 2A including a copper foil (thickness: 10 μm), and the resultant was dried to form a negative electrode active material layer 2, and thus a single-sided negative electrode with a negative electrode active material layer formed on one surface of a negative electrode current collector was produced. In the same manner, the negative electrode active material layer 2 was formed in each side of the negative electrode current collector 2A, and thus a double-sided electrode with a negative electrode active material layer formed on each side of a negative electrode current collector was also produced.

### Example 1

### <Preparation of Nonaqueous Electrolytic Solution>

Ethylene carbonate (EC), dimethyl carbonate (DMC), and methyl ethyl carbonate (MEC) were mixed together at a volume ratio (EC/DMC/MEC) of 20/40/40, and LiPF₆ and LiN(SO₂F)₂ (abbreviated as “LiFSI”) were dissolved therein to concentrations of 0.65 mol/L and 0.65 mol/L, respectively, and lithium difluorophosphate and the difluoroboron complex compound FB1 listed in Table 1 were dissolved therein to contents of 1% by mass and 0.4% by mass, respectively, to prepare a nonaqueous electrolytic solution.

### <Production of Lithium Ion Secondary Battery>

The positive electrode and graphite negative electrode produced in the above methods were shaped into a predetermined shape, and they were laminated with a porous film separator 3 sandwiched therebetween, and a positive electrode tab 1B and a negative electrode tab 2B were welded to the respective electrodes to obtain a power generation element. The power generation element was wrapped with an outer package including an aluminum laminate films 4, and the three edge portions were heat-sealed, and then the above nonaqueous electrolytic solution was injected thereinto for impregnation at an appropriate degree of vacuum. Thereafter, the residual one edge portion was heat-sealed under reduced pressure to obtain a pre-activated lithium ion secondary battery having the structure illustrated in FIG. 1.

### <Step of Activation Treatment>

The pre-activated lithium ion secondary battery produced was subjected to two cycles repeatedly each of which consists of charging to 4.2 V at a current per gram of the positive electrode active material of 20 mA/g, and discharging to 1.5 V at an identical current per gram of the positive electrode active material of 20 mA/g. Thus, a lithium ion secondary battery of the present Example was obtained.

### Example 2

A lithium ion secondary battery was produced in the same manner as in Example 1 except that the heat-treated graphite negative electrode was used as the negative electrode in place of the graphite negative electrode.

### Example 3

A lithium ion secondary battery was produced in the same manner as in Example 1 except that, in preparation of the nonaqueous electrolytic solution, 0.8% by mass of FB1 listed in Table 1 was added in place of 0.4% by mass of FB1 listed in Table 1.

### Example 4

A lithium ion secondary battery was produced in the same manner as in Example 1 except that, in preparation of the nonaqueous electrolytic solution, 0.4% by mass of FB2 listed in Table 1 was added in place of 0.4% by mass of FB1 listed in Table 1.

### Example 5

A lithium ion secondary battery was produced in the same manner as in Example 1 except that, in preparation of the nonaqueous electrolytic solution, 0.4% by mass of FB7 listed in Table 1 was added in place of 0.4% by mass of FB1 listed in Table 1.

### Example 6

A lithium ion secondary battery was produced in the same manner as in Example 1 except that 0.5 mol/L of LiPF₆ and 0.5 mol/L of LiN(SO₂F)₂ were added as the electrolyte in place of 0.65 mol/L of LiPF₆ and 0.65 mol/L of LiN(SO₂F)₂.

### Example 7

A lithium ion secondary battery was produced in the same manner as in Example 1 except that 0.3 mol/L of LiPF₆ and 0.7 mol/L of LiN(SO₂F)₂ were added as the electrolyte in place of 0.65 mol/L of LiPF₆ and 0.65 mol/L of LiN(SO₂F)₂.

### Example 8

A lithium ion secondary battery was produced in the same manner as in Example 1 except that 1.3 mol/L of LiPF₆ was added as the electrolyte in place of 0.65 mol/L of LiPF₆ and 0.65 mol/L of LiN(SO₂F)₂.

### Comparative Example 1

A lithium ion secondary battery was produced in the same manner as in Example 1 except that a nonaqueous electrolytic solution with neither lithium difluorophosphate nor the additive FB1 was used.

### Comparative Example 2

A lithium ion secondary battery was produced in the same manner as in Example 1 except that a nonaqueous electrolytic solution without the additive FB1 was used.

### Comparative Example 3

A lithium ion secondary battery was produced in the same manner as in Example 1 except that a nonaqueous electrolytic solution with 0.4% by mass of vinylene carbonate (VC) added in place of 0.4% by mass of the additive FB1 was used.

### Comparative Example 4

A lithium ion secondary battery was produced in the same manner as in Example 1 except that an electrolytic solution with 0.4% by mass of fluoroethylene carbonate (FEC) added in place of 0.4% by mass of the additive FB1 was used.

### Comparative Example 5

A lithium ion secondary battery was produced in the same manner as in Example 1 except that an electrolytic solution with 1.3 mol/L of LiN(SO₂F)₂ added as the electrolyte in place of 0.65 mol/L of LiPF₆ and 0.65 mol/L of LiN(SO₂F)₂ was used.

### <Evaluation Method for Lithium Ion Secondary Battery>

### (Charge Rate Characteristics)

Each of the above lithium ion batteries was charged to 4.2 V at a constant current of 0.1 C and discharged to 2.5 V at a constant current of 0.1 C in a thermostat bath kept at 20° C. to determine the discharge capacity at 0.1 C after the first cycle. Subsequently, each of the above lithium ion batteries was charged to 4.2 V at a constant current of 6 C and discharged to 2.5 V at a constant current of 0.1 C. From the ratio between the thus-acquired charge capacity at a charge rate of 6 C and the charge capacity at 0.1 C, the charge rate characteristics were determined by using the following formula.

Charge rate characteristics (%)=(charge capacity in charging at 6 C/charge capacity in charging at 0.1 C)×100

### (Capacity Retention Rate)

Subsequently, each of the secondary batteries after being determined for the charge rate characteristics was subjected to a test in which charging/discharging was repeated for 100 cycles within a voltage range of 2.5 V to 4.2 V at a charge/discharge rate of 6 C in a thermostat bath kept at 20° C., and thereafter charged to 4.2 V at a constant current of 0.1 C and discharged to 2.5 V at a constant current of 0.1 C to determine the recovered discharge capacity at 0.1 C. This cycle was repeated 30 times, that is, 3000 cycles in total of charging/discharging at 6 C were performed, and the capacity retention rate after the cycles was calculated by using the following formula.

Capacity retention rate (%)=(recovered discharge capacity at 0.1 C after 3000 cycles/discharge capacity at 0.1 C after first cycle)×100

### <Evaluation Results for Lithium Ion Secondary Batteries>

The compositions of electrolytic solutions, additives, amounts added, and evaluation results (charge rate characteristics, capacity retention rates) for Examples and Comparative Examples are summarized in Table 2.

TABLE 2

| | | | | Content | | |
|---|---|---|---|---|---|---|
| | | | | of | | |
| | Solvent composition and | Content of lithium | | additive | Charge rate | Capacity |
| | electrolyte in nonaqueous | difluophosphate | | (% by | characteristics¹⁾ | retention |
| | electrolytic solution | (% by mass) | Additive | mass) | (%) | rate (%) |
| Example 1 | EC/DMC/MEC(20/40/40) | 1 | FB1 | 0.4 | 72 | 79 |
| | 0.65M LiPF₆ + 0.65M LiFSI^{a} | | | | | |
| Example 2 | EC/DMC/MEC(20/40/40) | 1 | FB1 | 0.4 | 74 | 80 |
| | 0.65M LiPF₆ + 0.65M LiFSI | | | | | |
| Example 3 | EC/DMC/MEC(20/40/40) | 1 | FB1 | 0.8 | 71 | 80 |
| | 0.65M LiPF₆ + 0.65M LiFSI | | | | | |
| Example 4 | EC/DMC/MEC(20/40/40) | 1 | FB2 | 0.4 | 71 | 77 |
| | 0.65M LiPF₆ + 0.65M LiFSI | | | | | |
| Example 5 | EC/DMC/MEC(20/40/40) | 1 | FB7 | 0.4 | 71 | 78 |
| | 0.65M LiPF₆ + 0.65M LiFSI | | | | | |
| Example 6 | EC/DMC/MEC(20/40/40) | 1 | FB1 | 0.4 | 72 | 78 |
| | 0.5M LiPF₆ + 0.5M LiFSI | | | | | |
| Example 7 | EC/DMC/MEC(20/40/40) | 1 | FB1 | 0.4 | 73 | 78 |
| | 0.3M LiPF₆ + 0.7M LiFSI | | | | | |
| Example 8 | EC/DMC/MEC(20/40/40) | 1 | FB1 | 0.4 | 69 | 77 |
| | 1.3M LiPF₆ | | | | | |
| Comparative | EC/DMC/MEC(20/40/40) | none | none | — | 62 | 64 |
| Example 1 | 0.65M LiPF₆ + 0.65M LiFSI | | | | | |
| Comparative | EC/DMC/MEC(20/40/40) | 1 | none | — | 72 | 67 |
| Example 2 | 0.65M LiPF₆ + 0.65M LiFSI | | | | | |
| Comparative | EC/DMC/MEC(20/40/40) | 1 | VC | 0.4 | 71 | 67 |
| Example 3 | 0.65M LiPF₆ + 0.65M LiFSI | | | | | |
| Comparative | EC/DMC/MEC(20/40/40) | 1 | FEC | 0.4 | 70 | 66 |
| Example 4 | 0.65M LiPF₆ + 0.65M LiFSI | | | | | |
| Comparative | EC/DMC/MEC(20/40/40) | 1 | FB1 | 0.4 | 74 | —²⁾ |
| Example 5 | 1.3M LiFSI | | | | | |

1) Charge rate characteristics (%)=(charge capacity in charging at 6 C/charge capacity in charging at 0.1 C)×100
2) Capacity retention rate in Comparative Example 5: the corrosion of Al occurred during the cycles, and cycle evaluation failed.
3) “LiFSI” indicates LiN(SO₂F)₂.

From comparison of Examples 1 to 8 and Comparative Examples 1 to 5, it is understood that an electrolytic solution containing lithium difluorophosphate and further containing the difluoroboron complex compound represented by the general formula (1) provides excellent charge rate characteristics and allows retention of a high capacity retention rate even after cycles at high charge/discharge rates.

From the results, it was found that the nonaqueous electrolytic solution according to an exemplary embodiment, which contains an electrolyte and lithium difluorophosphate, and further contains a specific difluoroboron complex compound, is effective for achievement of excellent charge rate characteristics and enhancement of cycle characteristics (capacity retention rate) at high charge/discharge rates.

In the foregoing, the present invention has been described with reference to the exemplary embodiments and the Examples; however, the present invention is not limited to the exemplary embodiments and the Examples. Various modifications understandable to those skilled in the art may be made to the constitution and details of the present invention within the scope thereof.

### INDUSTRIAL APPLICABILITY

A lithium ion secondary battery using the nonaqueous electrolytic solution according to an exemplary embodiment has excellent charge rate characteristics and keeps a high capacity retention rate even after cycles at high charge/discharge rates, and thus can be utilized for all industrial fields requiring a power supply, and industrial fields relating to transportation, storage, and supply of electrical energy; and specifically, utilized for, for example, a power supply for mobile devices such as cellular phones, notebook computers, tablet terminals, and portable game machines; a power supply for travel/transport means such as electrical vehicles, hybrid cars, electric motorcycles, power-assisted bicycles, transport carts, robots, and drones (unmanned aerial vehicles); an electrical storage system for household use; a power supply for backup such as a UPS; and electrical storage equipment to store power generated through photovoltaic power generation, wind power generation, or the like.

The present application claims the right of priority based on Japanese Patent Application No. 2016-153029 filed on Aug. 3, 2016, the disclosure of which is incorporated herein by reference.

### REFERENCE SIGNS LIST

1: positive electrode active material layer
1A: positive electrode current collector
1B: positive electrode tab
2: negative electrode active material layer
2A: negative electrode current collector
2B: negative electrode tab
3: separator
4: outer package

1. A nonaqueous electrolytic solution comprising a nonaqueous solvent, an electrolyte, lithium difluorophosphate, and a difluoroboron complex compound represented by the following general formula (1): 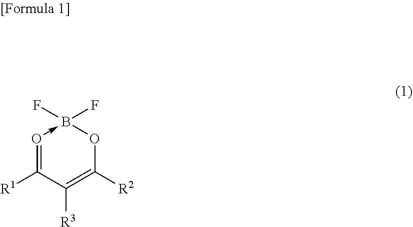
wherein R¹ and R² each independently represent a substituted or unsubstituted alkyl group having one to six carbon atoms, a substituted or unsubstituted aryl group, a substituted or unsubstituted heteroaryl group, or a substituted or unsubstituted alkoxy group, and R³ represents a hydrogen atom, a substituted or unsubstituted aryl group, or a substituted or unsubstituted heteroaryl group,
wherein a content of lithium bis(fluorosulfonyl)imide as the electrolyte is 0 to 80 mol % based on a total amount of moles of the electrolyte.

2. The nonaqueous electrolytic solution according to claim 1, wherein in the formula (1),
R¹ and R² are each independently a group selected from the group consisting of a methyl group, a trifluoromethyl group, a pentafluoroethyl group, a phenyl group, a 2-thienyl group, a 2-furanyl group, a 2-fluorophenyl group, a pentafluorophenyl group, a 4-fluorophenyl group, a 2,4-difluorophenyl group, a 4-cyanophenyl group, an ethoxy group, and a methoxy group, and
R³ is an atom or a group selected from the group consisting of a hydrogen atom, a phenyl group, a 2-thienyl group, a 4-fluorophenyl group, a 2,4-difluorophenyl group, and a pentafluorophenyl group.

3. The nonaqueous electrolytic solution according to claim 1, comprising lithium hexafluorophosphate and lithium bis(fluorosulfonyl)imide as the electrolyte.

4. The nonaqueous electrolytic solution according to claim 3, wherein a concentration of the lithium hexafluorophosphate is 0.3 mol/L or more.

5. The nonaqueous electrolytic solution according to claim 1, wherein a concentration of the electrolyte is in a range of 0.3 to 3 mol/L.

6. The nonaqueous electrolytic solution according to claim 1, wherein a content of the difluoroboron complex compound is in a range of 0.01 to 10% by mass based on a total mass of the nonaqueous electrolytic solution.

7. The nonaqueous electrolytic solution according to claim 1, wherein a content of the lithium difluorophosphate is in a range of 0.005 to 7% by mass based on a total mass of the nonaqueous electrolytic solution.

8. The nonaqueous electrolytic solution according to claim 1, comprising a carbonate as the nonaqueous solvent.

9. A lithium ion secondary battery comprising: a positive electrode comprising a positive electrode active material capable of occluding and releasing a lithium ion; a negative electrode comprising a negative electrode active material capable of occluding and releasing a lithium ion; and the nonaqueous electrolytic solution according to claim 1.

10. The lithium ion secondary battery according to claim 9, wherein the negative electrode active material comprises a graphite material.
